(19) United States
(12) Patent Application Publication
(10) Pub. No.: US 2011/0037318 A1
(43) Pub. Date: Feb. 17, 2011

(54) Integrated battery device

(76) Inventor: Chih-Peng Chang, Taichung City (TW)

Correspondence Address: Raymond Sun, 12420 Woodhall Way, Tustin, CA, 92782, US

(21) Appl. No.: 12/800,067

(22) Filed: May 7, 2010

(30) Foreign Application Priority Data
Aug. 16, 2009 (TW) 098214516

(51) Int. Cl. H02J 1/10

(52) U.S. Cl. 307/43

(57) ABSTRACT

An integrated battery device comprises two or more power battery sets, at least one DC-DC converter and a control unit. Each of the power battery sets has a battery level monitoring unit. The battery level monitoring unit is electrically connected with the control unit. Each of the power battery sets is electrically connected with a battery management system (BMS) and the DC-DC converter, and all of the power battery sets are electrically connected with the control unit in parallel. By the above configuration, the integrated battery device can completely exhaust the power battery sets without waste instead of affecting the service life of the power battery sets, so as to effectively improve durability of devices powered by the integrated battery device.

### BACKGROUND OF INVENTION

1. Field of the Invention

The present invention relates to power supply devices, and more particularly, to an integrated battery device incorporating two or more power battery sets therein and effectively managing and controlling an output voltage as well as remaining battery lifetime of the individual power battery sets therein.

2. Description of the Prior Art

With the progress and development of technology, varies new techniques have been continuously developed and implemented, in order to improve quality and fineness of products. Especially, the raising oil price and increasing environmental consciousness have encouraged the development and research on various environmentally friendly products. Therein, transportation, which is directly related to the consumption of gasoline, is highlighted by the industry as an R&D focus where large amounts of budgets are put. Transportation such development includes electric vehicles, electric motorcycles and electric bikes, wherein while electric vehicles still have problems about durability and capacity to be solved through more research, electric motorcycles and electric bikes have been successfully put into mass manufacture and commercialized. In particular, since an electric bike is designed to be optionally powered by manpower tread or electric motor, it is anyway operatable even when the power is low, without the problem of shutdown due to poor durability. On the other hand, when using electric bikes generally for short-distance, ordinary-duty transportation, users tend to require less from electric bikes in both capacity and speed. Thus, electric bikes currently enjoy the best consumer receptivity among the parallels thereof.

Meantime, although electric motorcycles have been well developed, all the modes thereof are now use a power battery set with a fixed capacity. In practical use, power battery sets have limited service life. Along with repeated discharging and recharging, a power battery set would have its available capacity gradually declined. When the remaining rechagability is less than 60% of the full rechagability of the power battery set, normal use of the power battery set can be significantly affected. For effectively solving or remedying the predicament, traditionally, the only approach is to replace the failed power battery set with a fully charged one, meaning that at least one spare power battery set has to be prepared and carried for in-situ replacement. In addition to the inconvenience and the complexity of brining and installing the spare power battery set, discarding the retired one, which still has 60% rechagability, would be very uneconomic and harmful to the environment. These are problems of the existing devices to be improved.

### SUMMARY OF INVENTION

The primary objective of the present invention is to provide an integrated battery device, which is capable of effectively managing and monitoring two or more power battery sets so as to provide a steady output voltage for an electric mechanism powered by the integrated battery device.

The secondary objective of the present invention is to provide an integrated battery device, which is capable of exhausting each power battery set therein before its replacement, so as to prolonging the service life of each said power battery set, thereby being more environmental friendly, and saving the cost and time otherwise required by more frequent replacement of power battery sets.

Another objective of the present invention is to provide an integrated battery device, which is capable of incorporating plural power battery sets without worrying about the differences among the power battery sets in their ages, capabilities, charging conditions and battery types, thereby being convenient in use.

To achieve the above and other objectives of the present invention, the disclosed integrated battery device primarily include two or more power battery sets, at least one DC-DC converter and a control unit. Each said power battery set has a battery level monitoring unit. The battery level monitoring unit is electrically connected with the control unit. Each said power battery set is electrically connected with a battery management system (BMS) and the DC-DC converter before all of the power battery sets are electrically connected with the control unit in parallel.

### BRIEF DESCRIPTION OF THE DRAWINGS

The present invention as well as a preferred mode of use, further objectives and advantages thereof will best be understood by reference to the following detailed description of illustrative embodiments when read in conjunction with the accompanying drawings, wherein:

FIG. 1 is a block diagram according to one embodiment of the present invention;

FIG. 2 is a block diagram according to another embodiment of the present invention; and

FIG. 3 is a block diagram illustrating the present invention wherein a single battery management system is implemented.

### DETAILED DESCRIPTION OF THE PREFERRED EMBODIMENT

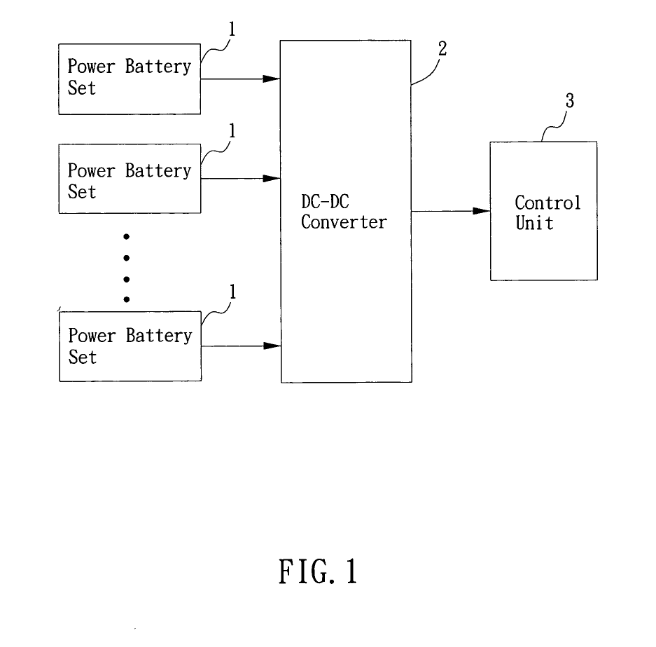

Please refer to FIG. 1 for a block diagram of an integrated battery device the present invention. The integrated battery device primarily comprises two or more power battery sets 1, at least one DC-DC converter 2 and a control unit 3. Therein, each of the power battery sets 1 is electrically connected with the DC-DC converter 2, and then the two or more power battery sets 1 are electrically connected with the control unit 3 in parallel.

By the foregoing configuration, no matter which said power battery set 1 is selected by the control unit 3 to supply power, DC-DC converter 2 serves to effectively control and fix an output voltage output by the integrated battery device to an external electric motor, thereby maintaining the output power steady.

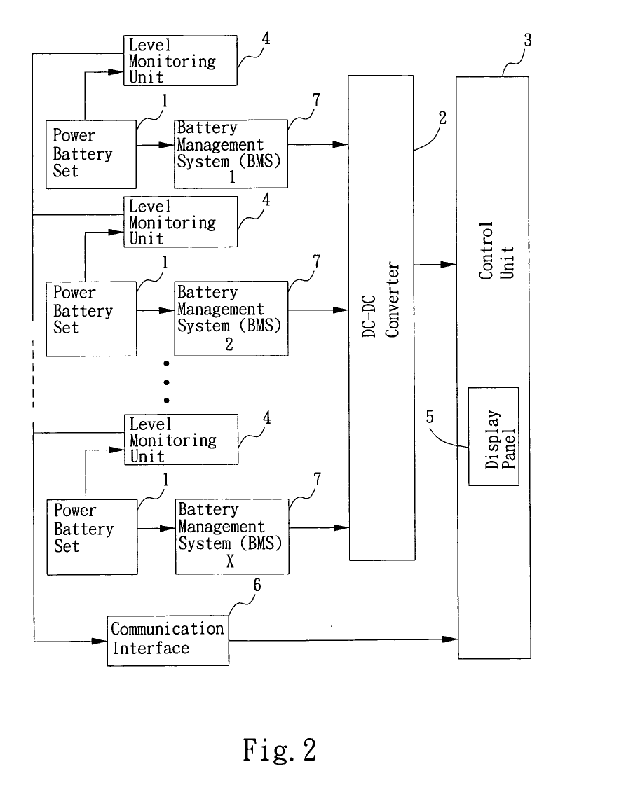

Furthermore, in the foregoing configuration of the present invention, a battery level monitoring unit 4 (as shown in FIG. 2) is provided between each said power battery set 1 and the control unit 3, so that the battery level monitoring unit 4 serves to automatically monitor the remaining battery lifetime of the power battery set 1 associated therewith and send the detected information to the control unit 3, allowing the control unit 3 to choose proper power battery set 1 for power supply under an automatic or manual operation. On the other hand, the control unit 3 further has a display panel 5, which serves to display the information about the remaining battery lifetime of every said power battery set 5, and the information about the identity of the power battery set 1 that is supplying power for the user's reference.

In addition, basing on the foregoing configuration of the present invention, a communication interface 6 is provided between the battery level monitoring unit 4 and the control unit 3. The communication interface 6 is configured to effectively read data acquired by the battery level monitoring unit 4, and transmit the same to the control unit 3, while displaying the same at the display panel 1 of the control unit 3. On the other hand, the communication interface 6 also serves to receive various control commands from the control unit 3, and accordingly activate the suitable power battery set 1 to supply power.

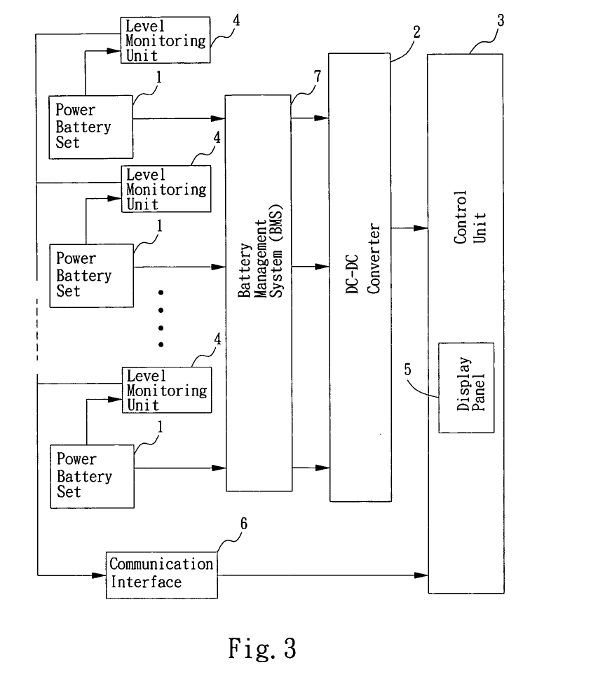

In order to achieve the optimal power supplying efficiency of every power battery set 1 in the disclosed device, between each said power battery set 1 and the DC-DC converter 2, a battery management system (BMS) 7 is further provided so as to manage the power battery sets 1 most effectively. As to the foregoing BMS 7, in addition to the use of a respective said BMS 7 for each said power battery set 1, in another embodiment, only one said BMS 7 is provided for the common use of all the power battery sets 1 (as shown in FIG. 3).

Moreover, the power battery sets 1 of the present invention are basically Li battery sets composed of Li-ion batteries or Li-polymer batteries being more stable than Li-ion batteries. In virtue of the DC-DC converter 2 implemented by the present invention, any voltage in a certain range can be converted into a constant output voltage by the DC-DC converter, so that there is less limitation to the adopted battery types, and a more flexible choice of batteries is available.

By the foregoing configuration of the present invention, the present invention can effectively integrate two or more power battery sets to convert their different output voltages of the power battery sets into a constant voltage for the use of an external electric motor, thereby effectively eliminating unexpected acceleration appearing on a vehicle using the electric motor or uncomfortableness caused to passengers on that vehicle during the shift of power supply between the power battery sets. Besides, the present invention can maximize the service life of the individual power battery sets, thereby reducing the frequency where the power battery sets need to be replaced and in turn saving costs while being contributive to environmental protection.

To sum up, the integrated battery device of the present invention is capable of conducting automatic adjustment according to the conditions of the power battery sets, thereby on one hand completely exhausting every said power battery sets, and on the other hand providing a powered electric motor with a steady output voltage and with improved durability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An integrated battery device, comprising two or more power battery sets, at least one DC-DC converter and a control unit; wherein each said power battery set is electrically connected with the DC-DC converter and then all of the two or more power battery sets are electrically connected with the control unit in parallel.

2. The integrated battery device of claim 1, wherein the power battery sets are electrically connected with only one said DC-DC converter.

3. The integrated battery device of claim 1, wherein each said power battery set is electrically connected with a said DC-DC converter respectively.

4. The integrated battery device of claim 1, wherein each said power battery Set has a battery level monitoring unit that is electrically connected with the control unit.

5. The integrated battery device of claim 4, wherein a communication interface is provided between the battery level monitoring unit and the control unit.

6. The integrated battery device of claim 1, further comprising at least one battery management system (BMS).

7. The integrated battery device of claim 6, wherein the power battery sets are electrically connected with only one said BMS.

8. The integrated battery device of claim 6, wherein each said power battery set is electrically connected with a respective said BMS.

9. The integrated battery device of claim 1, wherein the control unit has a display panel.
